(19) United States
(12) Patent Application Publication
(10) Pub. No.: US 2016/0275754 A1
(43) Pub. Date: Sep. 22, 2016

(54) Lottery Game Comprising Divisions Based on Jackpot Growth

(71) Applicant: John P. Hanus, Hartland, WI (US)

(72) Inventor: John P. Hanus, Hartland, WI (US)

(21) Appl. No.: 14/659,668

(22) Filed: Mar. 17, 2015

(51) Int. Cl. G07F 17/32

(52) U.S. Cl. CPC G07F 17/3258; G07F 17/329

(57) ABSTRACT

An improved method and system for conducting a recurring lottery event provides increased chances for a game participant to win a substantial prize by dividing into a plurality of sub-lotteries based on the size of the jackpot. The invention is designed to retain large jackpots to encourage participation while providing additional chances for a player to win a substantial prize.

### BACKGROUND OF THE INVENTION

The present invention relates to a method and system for conducting a recurring lottery event which is designed to retain a large jackpot while providing additional chances for a game participant to win a substantial prize.

### DESCRIPTION OF THE PRIOR ART

Most recurring lotteries feature a drawing of chance wherein each lottery participant pays a small fee, for example, $1 or $2, for the opportunity to win a large cash prize, or “jackpot”. To win the jackpot, the participant typically must match a subset of numbers of the participant's own selection or drawn by random computer selection from a larger predetermined pool of numbers, to a subset of numbers that are later drawn randomly from the pool by lottery officials. With current lotteries, cash prizes are funded by the monies risked by the participants, with the value of the cash prize for any particular drawing being at least partially dependent upon the amount of money paid by the participants of that particular lottery. If a winner of a particular lottery event is not selected, the jackpot will be retained to be part of the jackpot for the next lottery event.

One limitation of existing lotteries is that when participation in a particular lottery is low for long stretches of time, the vitality of the lottery and therefore the financial return to the lottery organizers is diminished. States and other involved entities suffer financially when jackpots do not pay out on a regular basis but rather grow to large amounts and the winnings are distributed outside the area. Another limitation of existing lotteries is that the chances of winning are so remote, potential participants are deterred from entering the lottery until the jackpot is very large. With jackpots that are not won in a first lottery drawing rolled over into the next drawing, some potential participants may be inclined to wait until the jackpot has grown to a substantial amount before entering the lottery.

An improved lottery method therefore would retain a large jackpot and provide better chances for a participant to win a substantial prize while increasing the likelihood that a winner will be chosen from a local venue.

In a conventional lottery, participants receive a chance to win by purchasing a ticket which includes a set of numbers chosen from a plurality of numbers of a predetermined universe. The ticket purchase along with purchases from other participants represent the ‘jackpot’ or the amount to be remitted to the owner of the ticket featuring the numbers that match the numbers selected by the lottery officials. In many cases, a winning ticket is not drawn and the jackpot amount is added to the next lottery event, thereby increasing the jackpot. Growth in the size of the jackpots has increased participation in lottery games, and has also resulted in huge payouts.

When jackpots become extremely large, participants feel more comfortable when a group of players win the jackpot rather than a single person. A more equitable lottery would provide a smaller but still substantial jackpot combined with more chances to win. As an example, a lottery which could produce six $100 million winners rather than one $600 million winner would be considered to be more socially acceptable to many lottery participants.

To answer this problem while retaining interest in the game, the present invention presents an alternative method which features large jackpots to encourage participation while providing more chances for the participant to win a substantial prize.

### BRIEF SUMMARY OF THE INVENTION

Referring to conventional lotteries, numbers are drawn and participants with winning numbers are paid or the amount of the jackpot is rolled over into the next lottery event. This action continues, with subsequent lotteries resulting in large jackpots. Referring to the present invention, once the primary jackpot reaches a ‘threshold’, this being a numerical amount which is predetermined by the lottery officials, the primary jackpot will be divided into 2 sub-jackpots, or 3 sub jackpots etc., depending on the size of the primary jackpot, and will feature a corresponding number of drawings. The participant's lottery ticket numbers will be eligible in each of these resulting sub-jackpots, thereby increasing their odds of winning. Because the primary jackpot will only divide once it reaches a substantial threshold, which could also be considered a ‘minimum’ jackpot amount, the primary jackpot and the resulting sub-jackpots will remain at a substantial level while creating more chances to win. As the primary jackpot grows and reaches each successive threshold, the primary jackpot will divide accordingly and each ticket will present more chances to win. For example, in a preferred but not limiting embodiment, if the primary jackpot does not reach the 1st threshold, 1 set of numbers are drawn, when the primary jackpot reaches the 1st threshold but not the 2nd threshold, 1 drawing is still performed. When the primary jackpot reaches the 2nd threshold, 2 separate drawings are performed, each for ½ the jackpot, if the 3rd threshold is met, 3 drawings will be performed, each for ⅓ the primary jackpot, etc. The advantage to the participant will be that as the primary jackpot increases, the participant will receive additional chances to win a substantial prize for the same investment. Additionally, as the primary jackpot increases, the increased chances created will have the effect of encouraging other participants to play, thereby further increasing the primary jackpot. If the primary jackpot has not reached the 1st threshold, and a winner is determined, the entire primary jackpot is paid to the winner. If no winner is determined, the primary jackpot is rolled into the primary jackpot for the next lottery event but remains a 1 drawing lottery event until the primary jackpot reaches the 2nd threshold, an amount which represents twice the first threshold, and wherein the primary jackpot splits into 2 sub-jackpots, with 2 drawings made. In a preferred embodiment, if 2 winners are established in a 1 lottery event drawing, 2 payouts are made, each for ½ the primary jackpot. If 1 number combination matches in a 2 drawing event, the owner of the ticket will receive ½ of the primary jackpot, with the other ½ retained to be part of the next primary jackpot. This will have the effect of always retaining a substantial primary jackpot at the start of a drawing. If there are no matching numbers, the entire primary jackpot rolls into the next lottery event. If the primary jackpot reaches the 3rd threshold, the primary jackpot will be divided into 3 equal sub jackpots with 3 drawings made. Larger future primary jackpots will be divided in like manner with a corresponding number of drawings. In a preferred embodiment, if more winners are determined than the amount of sub-jackpots, the primary jackpot will be divided by the number of winners.

In a secondary embodiment, each sub-jackpot will be considered a separate lottery. In this embodiment, if there are more than one winner, or those participants with the same winning numbers, the sub jackpot that includes the winners will be divided, the balance of the other sub jackpots retained for the next lottery event. For example, once the primary jackpot reaches a threshold and divides, each sub-lottery is considered a separate lottery. If there are more than one participant with the same matching numbers, each winner will receive an equal portion of the sub-lottery jackpot. If there are more than 2 participants with the same winning numbers in a sub-lottery, the sub-lottery jackpot will be divided by the amount of winners. After the primary lottery divides, each sub-lottery will be treated as a separate lottery, with rules of division similar to those of the primary lottery event. Other payout plans could be utilized without deviating from the scope of the invention.

Incorporating either embodiment, once the lottery divides, the drawings could be conducted consecutively during 1 lottery drawing event or the second and additional drawings could be conducted at a later time or date to promote interest in the game.

Relating to the present invention, the primary jackpot and subsequent sub-jackpots will remain large, having the effect of motivating participants to purchase tickets due to the increased chances they will win a substantial prize. The primary jackpot could be divided into any number of sub jackpots depending on the monetary threshold upon which the primary jackpot will divide as determined by the lottery organizing body and the size of the primary jackpot.

The invention will incorporate large jackpots while increasing the number of payouts, thus eliminating the mega jackpots of, for example, $500 million, by instead, in this example, providing chances for 5 participants to each win $100 million. The primary jackpot will be divided depending on the threshold chosen by the lottery organizing body and the size of the primary jackpot. In a preferred embodiment, if the threshold is set at $100 million and the primary jackpot reaches $250 million, the next threshold of $300 million is not reached, therefore the primary jackpot will be divided into 2 sub jackpots of 125 million each and 2 drawings will be performed.

The system of the present invention may be used to conduct the steps of the method. The system comprises one or more electronic devices, operable by agents of the lottery organizing body acting as vendors, and/or by participants of the present lottery. These electronic devices may include, for example, ticket dispensing machines and computers, with the electronic devices including computer-executable software stored on a computer-readable medium. The software may be incorporated to conduct one or more steps of the method. In a future embodiment and with appropriate safeguards, the method could also be performed through the use of private computers and the internet to complete the transactions.

The method of the present invention may be incorporated into existing lottery games. For example, as with the present invention, participants of both Powerball and Megabucks are required to purchase a ticket at a ticket vendor location which includes a ticket printing machine connected to a computer which is in turn connected to a larger main computer. The ticket includes a subset of numbers of the participant's own selection or by random computer selection from a larger pool of numbers from which an equal set of numbers are later drawn by lottery organizers. Any contemporary lottery method which includes a computerized system could be altered to include the steps of the present invention. “Multiplier” enhancement lottery techniques could be continued and partial jackpot payout formulas could be incorporated.

The advantage of the invention to lottery organizers will be the likelihood that substantial jackpots will be retained and more payouts made to local participants. The advantage to the participant will be multiple chances to win a substantial jackpot rather than one chance to win a larger jackpot.

### BRIEF DESCRIPTION OF THE DRAWING

FIG. 1 Describes the interaction between the lottery organizing body, the main systemwide computer, the remote satellite computers, the ticket printing device, the vendor and the lottery participant.

FIG. 2 Describes a flow chart of the invention showing the lottery organizing body, various jackpot and sub-jackpot configurations, the lottery participants and the action of the invention on the flow of funds.

### DETAILED DESCRIPTION OF A PREFERRED EMBODIMENT

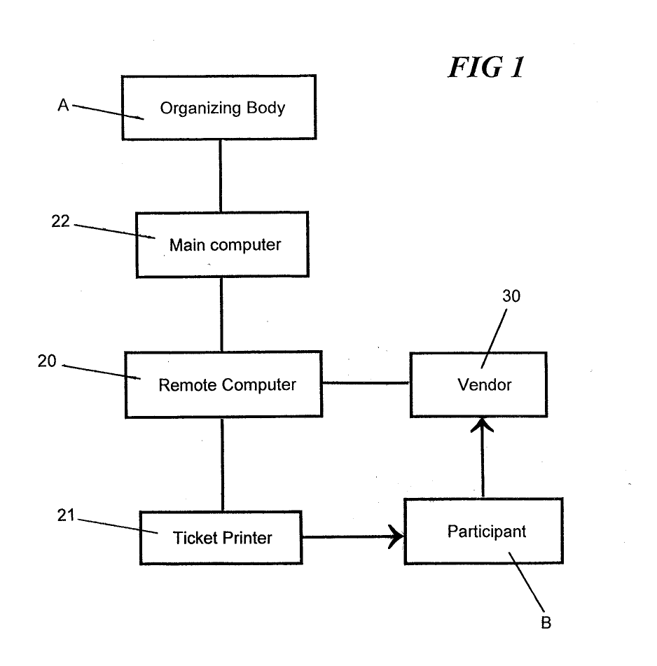

Referring to FIG. 1, a lottery organizing body A constructs a lottery by combining a main systemwide computer 22 with remote satellite computers 20 that operate ticket vending machines 21 in communication with the main computer 22 thereby registering sales and number selection. The lottery organizing body A creates the rules to determine a winner and establish the universe of numbers from which participants B will make their number selection and from which winning numbers will be drawn in a lottery event. Participant B purchase chances to win typically in the form of lottery tickets which include a subset of numbers picked by the participant B from the predetermined universe of numbers or by random computer selection. The tickets are purchased from a lottery ticket vendor 30, who utilizes computer 20 to communicate with the main systemwide computer 22 and the ticket printer 21.

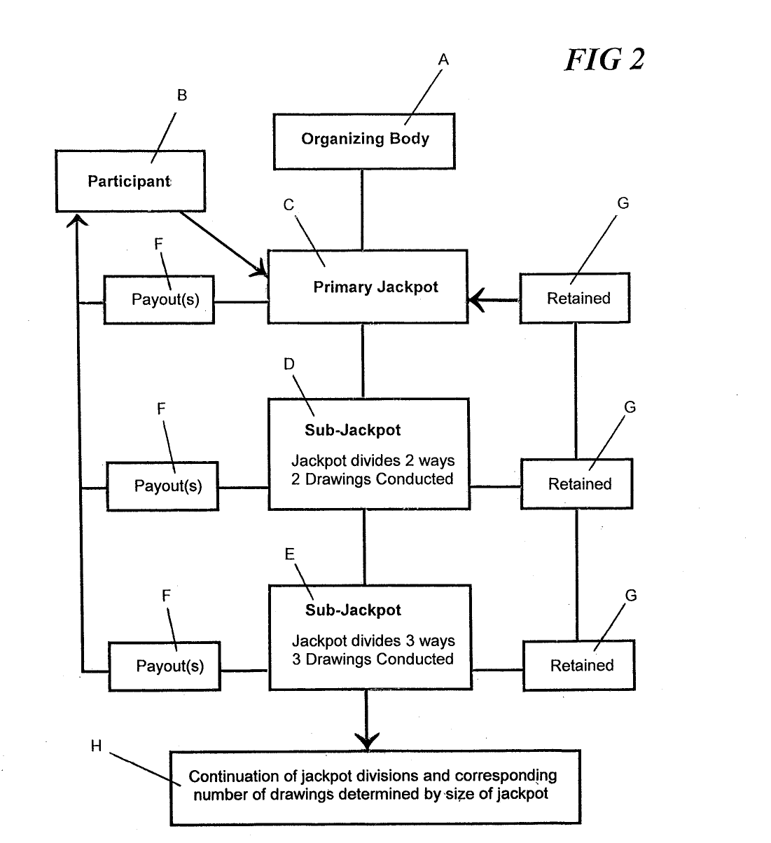

As shown in FIG. 2, the total monetary value of all ticket purchases is represented by primary jackpot C from which winning monies will be distributed. Numbers are drawn from the predetermined universe of numbers by the lottery organizing body A or its authorized officials with winning tickets determined by matching participant B numbers with the numbers drawn. Increasing numbers of jackpot divisions represented as D, E and H etc. are determined by the size of the primary jackpot C. If the primary jackpot C is below the 2nd established threshold, the total amount F will be paid to the lottery participant B holding the numbers that match the numbers drawn by the lottery organizing body A. If no winner is selected, the retained amount G is rolled into the next drawing, with monies brought in from new lottery ticket sales further increasing the size of the primary jackpot C. If the primary jackpot C remains above the predetermined threshold but below the next threshold, the lottery will continue as a single lottery with 1 winning number combination selected. If the amount in the jackpot reaches a second threshold, that typically being twice the 1st threshold, the primary jackpot C will split into 2 sub jackpots each equal to ½ of the primary jackpot C and represented as D and 2 separate number selections will be drawn. In effect, the participant will receive 2 chances to win ½ of the primary jackpot C. Again, whatever amount G not paid out to a winner will be retained to be part of primary jackpot C to be used in a subsequent lottery. If primary jackpot C increases and reaches a 3rd threshold E, primary jackpot C will be divided into 3 sub-jackpots with each sub jackpot representing ⅓ of the primary jackpot C and 3 drawings will be held. As the primary jackpot C becomes larger, more divisions will be made to the primary jackpot C as well as a proportional amount of drawings conducted, herein represented as H. In effect, the size of the primary jackpot C will determine the amount of sub-lotteries and the corresponding amount of drawings performed. The larger the primary jackpot C, the greater the number of chances a participant will receive to win a substantial prize. Variations on the invention could include ways of dividing the primary jackpot C. For example, in a preferred embodiment, if 3 or more winners are selected from a 2 way divided jackpot, the primary jackpot C would be divided by the number of winners, in this case being 3 or more. In another example, 1 winner in a 3 way sub jackpot will receive ⅓ of the primary jackpot, 3 winners would result in the entire primary jackpot being paid out, ⅓ to each winner. In one embodiment, if 4 winners are determined in a 3 way jackpot, the primary jackpot C will be divided into ¼ths with each participant receiving ¼th of the primary jackpot C. In the described embodiment, the primary jackpot C will not be divided among the winners by less than the threshold divisions. For example, in a lottery featuring 3 sub-jackpots, primary jackpot C will not be divided 2 ways. The thresholds could be set at any numerical level desired. For example, the threshold could be set to create 60 chances to win $10 million for participant B of a jackpot of $600 million. Other divisions and partial payout schedules could be included without deviating from the scope of the invention.

The present invention also comprises a system for conducting the method of the present invention. As shown in FIG. 1, in one embodiment, a plurality of electronic devices 20 are connected to ticket dispensing machines 21 located on the premises of a plurality of vendors 30. The vendors 30 include for example, convenience stores, grocery stores, gas stations, liquor stores, pubs and eateries, but are not limited thereto. Some of the ticket dispensing machines 21 are operable by a representative of the agent 30, such as a store clerk/cashier of a convenience store, for example, and some of the ticket dispensing machines 21 are operable by the participant B themselves. When the ticket dispensing machines 21 are operable by the participant B, the ticket dispensing machine 21 is capable of receiving money paid by the participant B in exchange for one or more tickets and is capable of dispensing the ticket including the numbers selected. When the ticket dispensing machine 21 is operable by the representative of the vendor 30, the ticket dispensing machine 21 is capable of dispensing the ticket and is optionally capable of receiving the money.

The ticket dispensing machine 21 is in communication with a remote electronic device 20 which is monitorable by lottery organizing body A through a main electronic device 22, with all electronic devices typically being computers. The remote electronic device 20 is capable of receiving information to and from the ticket dispensing machine 21. The main electronic device 22 is in communication with each remote electronic device 20 and is capable of calculating and storing information regarding the method. This information may be, but is not limited to being, for example, the total number of participants B entered for a particular drawing, the total amount of money paid by the participants B to enter that particular drawing, the identifying features associated with any particular ticket and the number of winners that will be determined for that particular drawing. The remote electronic device 20 may be capable of directing the ticket dispensing machine 21 to print out a ticket having the identifying features including the numbers selected and any other information that may be on the face of the ticket, such as bar coding or other identification technology, the time and date of the drawing for which the ticket is valid and the money paid by the participant B in exchange for the ticket, for example.

The system 10 of the present invention further includes computer-executable software stored on a computer-readable medium, the computer-executable software capable of being used to conduct one or more steps of the method. For example, the software may be included as part of the ticket dispensing machine 21 and the remote electronic devices 20 as well as the main computer 22.

The computer-executable software includes computer-readable signals tangibly embodied on the computer-readable medium, where such signals define instructions for processing data entered by the representative of the vendor 30 or by the participant B or received from the lottery organizing body A through main computer 22.

1. A method and system for conducting a recurring lottery event comprising:
sale of tickets to lottery participants, the aggregate sum of said sales creating a primary lottery jackpot, said tickets featuring a set of numbers chosen through random computer selection or by said participant from a predetermined universe of numbers from which, in turn, a set of numbers are subsequently chosen in a drawing event held by a lottery organizing body, winners determined by matching said participant's number set with the number set chosen during said drawing event,
said lottery event being conducted as a single event or divided into a plurality of smaller sub-lottery events comprising a plurality of smaller jackpots and a corresponding number of drawings, the number of said drawings determined through a formula created by said lottery organizing body, said formula defining preset thresholds incorporated to divide said lottery event into a plurality of said sub-lottery events based on the size of said primary lottery jackpot.

2. The method and system for conducting a recurring lottery event of claim 1, said lottery event comprising:
setting said lottery event date and time,
creating said primary lottery jackpot by selling tickets for said lottery event through remote ticket distribution sites, said sites featuring computer terminals coordinated with a main systemwide computer,
determining said aggregate sum of said primary lottery jackpot by adding receipts from said ticket purchases combined with undistributed funds from prior jackpots and dividing said primary lottery jackpot by said preset jackpot threshold, thereby establishing either a single said lottery event or a plurality of substantially equal said sub-lottery events and corresponding said sub-lottery jackpots,
conducting said lottery drawing or said sub-lottery drawings from said predetermined universe of numbers,
determining winning numbers and distributing proportional funds from said primary lottery jackpot or said sub-lottery jackpots,
retaining undistributed funds from said primary lottery jackpot or said sub-lottery jackpots to be included in said primary jackpot to be used in a subsequent lottery event.

3. The method and system for conducting a recurring lottery event of claim 2 wherein the number of said sub-lottery events is determined by the number of times as a whole number said preset jackpot threshold can be divided into said primary lottery jackpot.

4. The method and system for conducting a recurring lottery event of claim 2 wherein said main lottery jackpot is divided by the number of said winners.

5. The method and system for conducting a recurring lottery event of claim 2 wherein each said sub-lottery event is treated as an independent lottery event and wherein said participants with identical winning numbers are paid only from said sub-lottery event jackpot.

6. The method and system for conducting a recurring lottery event of claim 2 wherein said sub-lottery jackpots are equal in value.

7. The method and system for conducting a recurring lottery event of claim 2 wherein said sub-lottery jackpots are unequal or staggered in value.

8. The method and system for conducting a recurring lottery event of claim 2 wherein said sub-lottery drawings are conducted consecutively in one event.

9. The method and system for conducting a recurring lottery event of claim 2 wherein said sub-lottery drawings are conducted at separated intervals in date or time.
